(19) United States
(12) Patent Application Publication
(10) Pub. No.: US 2002/0066164 A1
(43) Pub. Date: Jun. 6, 2002

(54) Rotating handle grip for wheeled luggage apparatus

(76) Inventor: Kenneth E. White, Libertyville, IL (US)

Correspondence Address: Douglas B. White, 1000 East Woodfield Road, Suite 102, Schaumburg, IL, 60173, US

(21) Appl. No.: 09/731,104

(22) Filed: Dec. 6, 2000

(51) Int. Cl. B62B 1/00

(52) U.S. Cl. 16/436

(57) ABSTRACT

The rotating handle grip includes a two piece inner support member which is mounted to the extending arms of the luggage apparatus. The separate sections of the inner support for the handle engage each other with a locking tab device to provide a secure and rigid inner support for the handle. A foam rubber cylindrical grip and a bearing cylinder are positioned over the inner support member to provide an easily rotatable grip.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates generally to luggage carts and wheeled luggage which employs a handle mounted to arms extending from the wheeled luggage or cart. More particularly this invention relates to an improvement in the handle for such apparatus which facilitates the use thereof by allowing for natural rotation of the grip on the handle.

2. Description of the Prior Art

Prior art luggage carts and wheeled luggage generally employ handles which are rigidly fixed to the extending arms of the luggage apparatus. Consequently, when the user is ascending or descending stairs, the position of the user's hand must be repeatedly changed to compensate for the change in position of luggage apparatus relative to the user.

### SUMMARY OF THE INVENTION

Accordingly, it is an object of the present invention to provide a rotating handle grip which will adjust to the varying position of the user. It is also an object of this invention to provide a design for a handle with a rotating grip which is economical to manufacture and easy to assemble.

The rotating handle grip of the present invention includes a two piece inner support for the handle which is mounted between handle supports on the extending arms of the luggage apparatus. The separate sections of the inner support for the handle engage each other with a locking tab device to provide a secure and rigid inner support for the handle. An outer foam rubber cylinder and an inner bearing cylinder are positioned over the inner support member to provide an easily rotatable grip.

### BRIEF DESCRIPTION OF THE DRAWINGS

FIG. 1 is a perspective view of luggage apparatus employing a rotating handle grip in accordance with the present invention.

FIG. 2 is a cross section view of the handle of FIG. 1 depicting the rotating feature.

FIG. 3 is a perspective view of the rotating grip handle of FIG. 1.

FIG. 4 is a perspective exploded view of the handle of FIG. 3.

FIG. 5 is a perspective partially cutaway view of the handle of FIG. 3 showing the engagement of the inner support of the handle.

FIG. 6 is a cross section of the center portion of the handle of FIG. 3 showing the engaging mechanism of the handle assembly.

While the invention will be described in connection with a preferred embodiment, it will be understood that it is not the intent to limit the invention to that embodiment. On the contrary, it is the intent to cover all alternatives, modifications, and equivalents as may be included within the spirit and scope of the invention as defined by the appended claims.

### DESCRIPTION OF THE PREFERRED EMBODIMENT

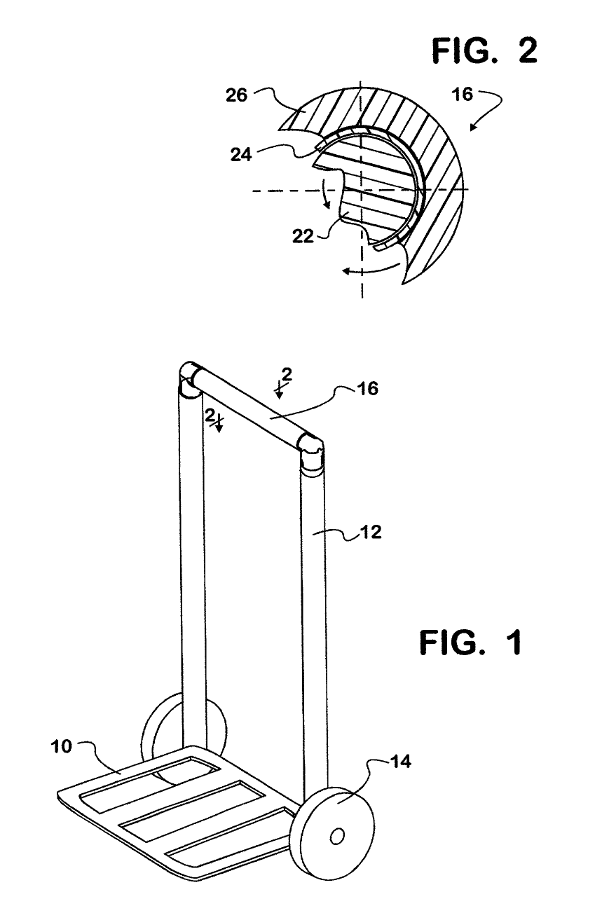

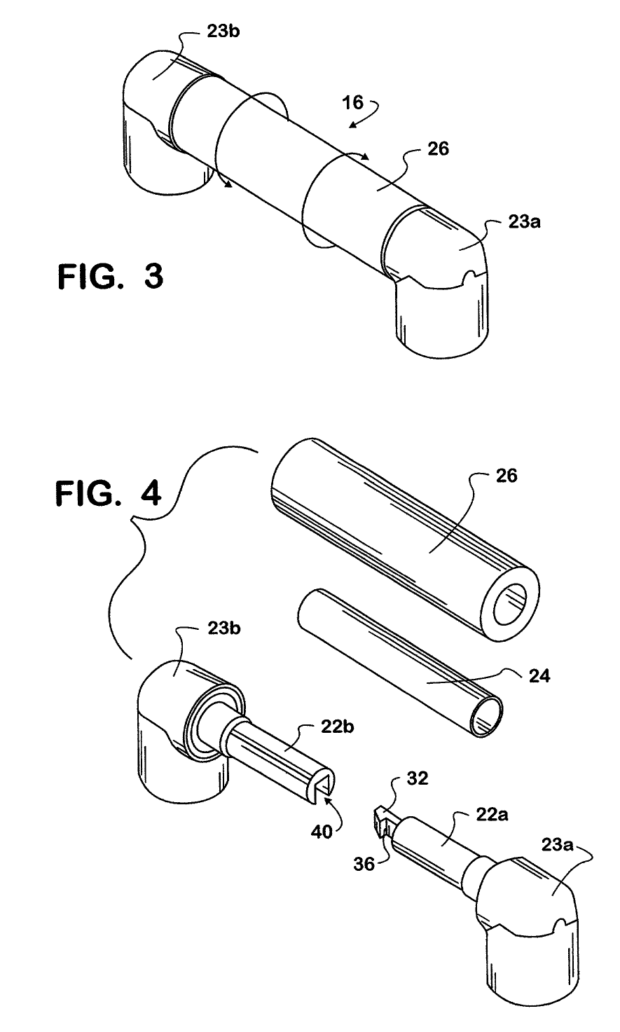

Turning first to FIG. 1 wheeled luggage apparatus is shown incorporating a rotating handle grip in accordance with the present invention. Luggage (not shown) in the nature of a case or bag may be temporarily or permanently attached to, or integral with, the frame of the wheeled apparatus. This wheeled luggage apparatus generally includes a base frame 10 having arms 12 extending upwardly therefrom and wheels 14 positioned at the bottom of the base frame. Mounted between the extending arms 12 of the wheeled luggage apparatus is a rotating handle grip 16. When the user grasps the rotating handle grip 16, its free rotation (FIG. 3) allows it to continuously adjust to the changing position of the user.

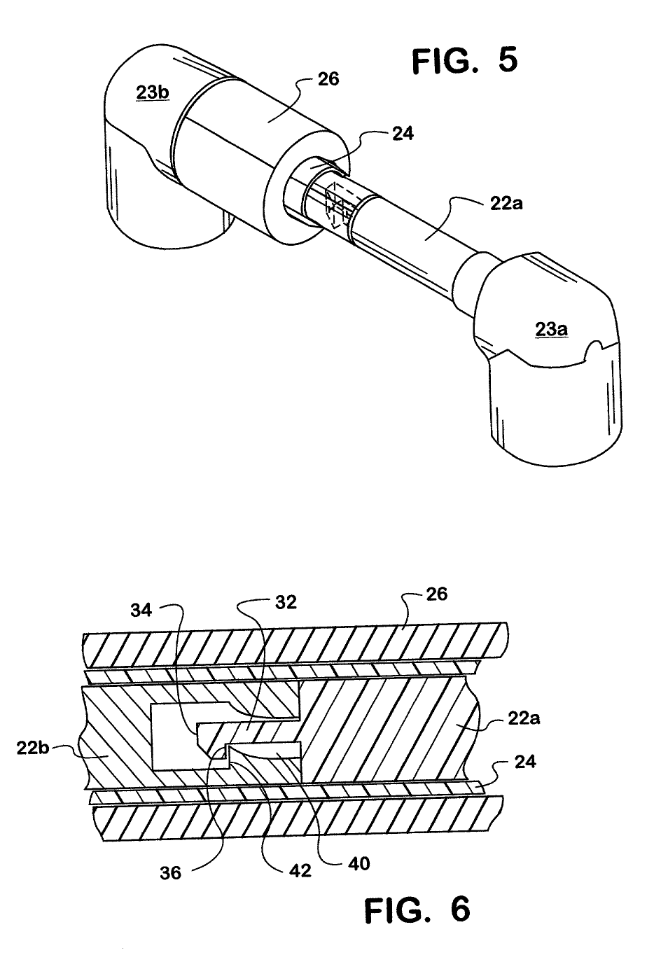

The rotating grip handle 16 of the present invention is supported by a rigid two piece inner support member 22, as more fully described below. This inner support member 22 of the handle is arranged to extend between handle supports 23a and 23b, which supports are affixed to respective extending arms of the luggage apparatus. Bearing means in the nature of a smooth surfaced cylinder 24 is positioned on the inner support member 22 for reducing friction during rotation of the grip (see FIGS. 4 and 5). Finally, an outer grip member 26, preferably composed of a foam rubber type of material, is positioned on the bearing cylinder 24, thereby providing a secure grip during the free rotation of the handle grip 16 (FIG. 3).

The inner support member 22 is comprised of two engaging members 22a and 22b which join together to form the rigid inner support member 22 of the rotating handle grip 16. For joining these two engaging members 22a and 22b of the inner support member there is provided engaging means, such as the locking tab device depicted in FIG. 6. This engaging means allows for easy assembly by quickly securing the two engaging members together when they are pressed together.

The locking tab device of the preferred embodiment includes a flexible tab 32 protruding from the engaging extremity of the first engaging member 22a. This tab presents a head 34 and a tab locking edge 36. A channel 40 extends into the engaging extremity of the second engaging member 22b . This channel 40 is curved and presents a channel locking edge 42 therein. During insertion of the tab, the tab bends while the tab head follows the curvature of the channel. When the tab locking edge 36 passes the channel locking edge 42, the tab is fully inserted and the tab snaps into the locked position shown in FIG. 6, engaging the locking edges and securing the first and second engaging members together.

Assembly of the rotating grip of the present invention is accomplished by first affixing the supports 23a and 23b to respective extending arms of the wheeled luggage apparatus. First and second engaging members of the inner support member are then affixed to the supports 23a and 23b. Alternatively, a support and its respective engaging member may be manufactured as an integral unit and installed as one step. With the supports and the engaging members installed on the luggage arms, the bearing cylinder 24 and grip 26 are positioned on the separated, un-engaged first and second engaging members. Finally, the tab 32 is inserted into the channel 40 and the engaging members are pressed together to complete the assembly.

From the foregoing description, it will be apparent that modifications can be made to the handle apparatus without departing from the teachings of the present invention. Accordingly, the scope of the invention is only to be limited as necessitated by the accompanying claims.

What is claimed is:

1. A rotating handle grip for wheeled luggage apparatus comprising:
an inner support member; and
a grip member mounted on said inner support member for rotation thereon.

2. The rotating grip of claim 1 wherein said inner support member comprises first and second engaging members, and further comprises engaging means for engaging said first and second engaging members.

3. The rotating grip of claim 2 wherein said engaging means comprises a locking tab device.

4. The rotating grip of claim 3 wherein said locking tab device comprises a tab extending from said first engaging member and a channel defined within said second engaging member, and further comprising a first locking edge defined on said tab and a second locking edge defined within said channel, wherein said tab extends into said channel during engagement of said engaging members to engage said first and second locking edges.

5. The rotating grip of claim 1 further comprising bearing means mounted on said inner support member for reducing frictional resistance to said rotation of said grip member.

6. The rotating grip of claim 5 wherein said inner support member comprises first and second engaging members, and further comprises engaging means for engaging said first and second engaging members.

7. The rotating grip of claim 6 wherein said engaging means comprises a locking tab device.

8. The rotating grip of claim 7 wherein said locking tab device comprises a tab extending from said first engaging member and a channel defined within said second engaging member, and further comprising a first locking edge defined on said tab and a second locking edge defined within said channel, wherein said tab extends into said channel during engagement of said engaging members to engage said first and second locking edges.

9. The rotating grip of claim 5 wherein said bearing means comprises a cylinder member having a smooth surface.

10. The rotating grip of claim 9 wherein said inner support member comprises first and second engaging members, and further comprises engaging means for engaging said first and second engaging members.

11. The rotating grip of claim 10 wherein said engaging means comprises a locking tab device.

12. The rotating grip of claim 11 wherein said locking tab device comprises a tab extending from said first engaging member and a channel defined within said second engaging member, and further comprising a first locking edge defined on said tab and a second locking edge defined within said channel, wherein said tab extends into said channel during engagement of said engaging members to engage said first and second locking edges.

13. The rotating grip of claim 1 wherein said grip member is comprised of a foam rubber material.

14. The rotating grip of claim 13 wherein said inner support member comprises first and second engaging members, and further comprises engaging means for engaging said first and second engaging members.

15. The rotating grip of claim 14 wherein said engaging means comprises a locking tab device.

16. The rotating grip of claim 15 wherein said locking tab device comprises a tab extending from said first engaging member and a channel defined within said second engaging member, and further comprising a first locking edge defined on said tab and a second locking edge defined within said channel, wherein said tab extends into said channel during engagement of said engaging members to engage said first and second locking edges.

17. The rotating grip device of claim 13 further comprising bearing means mounted on said inner support member for reducing frictional resistance to said rotation of said grip member.

18. The rotating grip of claim 17 wherein said bearing means comprises a cylinder member having a smooth surface.

19. The rotating grip of claim 18 wherein said inner support member comprises first and second engaging members, and further comprises engaging means for engaging said first and second engaging members.

20. The rotating grip of claim 19 wherein said engaging means comprises a locking tab device.
